(19) United States
(12) Patent Application Publication
(10) Pub. No.: US 2020/0391167 A1
(43) Pub. Date: Dec. 17, 2020

(54) CLOSED COLORANT DELIVERY SYSTEM AND METHOD OF USE

(71) Applicants: BASF SE, Ludwigshafen am Rhein (DE); Behr Process Corporation, Santa Ana, CA (US)

(72) Inventors: Christopher J. Valovic, Charlotte, NC (US); Bruce Boos, McDonough, GA (US)

(21) Appl. No.: 16/898,190

(22) Filed: Jun. 10, 2020

Related U.S. Application Data
(60) Provisional application No. 62/860,322, filed on Jun. 12, 2019.

(51) Int. Cl. B01F 13/10; C09D 7/80; B44D 3/04

(52) U.S. Cl. CPC B01F 13/1055; B01F 2215/005; B44D 3/04; C09D 7/80

(57) ABSTRACT

A tinting system includes a storage system and a colorant dispenser. The storage system includes a container that defines a fluid-tight, sealed chamber within which a colorant containing reduced levels of biocide (fungicide and/or bactericide) is stored. A valve is positioned at and sealed to an opening provided in the container. The colorant dispenser includes an inlet configured to be releasably and removably attached to the valve of the container. A pump and dosing valve of the colorant dispenser are operated to dispense colorant from the storage system through a discharge nozzle of the colorant dispenser. The dispensed colorant may be used to tint an aqueous-based paint.

### CROSS-REFERENCE TO RELATED APPLICATIONS

The present application claims the benefit of and priority to U.S. Patent Application No. 62/860,322, filed on Jun. 12, 2019, the contents of which are incorporated herein in their entirety.

### FIELD

The present technology is generally related to a tinting system, and, more specifically, to a paint tint system and methods of use thereof.

### BACKGROUND

In existing tinting assemblies, a dispenser device is refilled with colorant by pouring the contents of a colorant container into a designated colorant chamber of the dispenser device. Although the container in which the colorant is provided is initially sealed, the colorant is exposed to the ambient environment upon opening of the container. Thus, once the original sealed container in which the colorant was originally provided has been opened, the colorant remains exposed to the environment, and thus at risk of contamination, until it is dispensed by the dispenser. Additionally, because the dispenser chambers into which colorant is poured are not typically cleaned prior to refilling, new colorant poured into the chamber may be further subject to contamination and spoilage from remnants of previously stored colorant within the chamber. For example, colorant may accumulate on the sidewall defining the chamber to form a film and provide an ideal environment for microbe proliferation.

In addition to the risk of contamination posed by existing tinting assemblies, the uncontrolled and unmetered method of refilling colorant in such existing systems results in wasted colorant, and increased costs associated therewith. The size and shape of existing colorant containers make the pouring of colorant into a chamber cumbersome, often leading to colorant being spilled during the refilling process. Additionally, colorant may be wasted as a result of pouring colorant into the wrong chamber of the dispenser device. Moreover, although volume of colorant dispensed by the dispenser may be closely monitored, the volume of colorant within the chamber is not. Given the inability to measure a precise volume of colorant remaining in the chamber, users often resort to prematurely refilling the chamber of the dispenser device. Because of the existing colorant within the chambers at the time of refilling, the entirety of the colorant within the container is often not transferred into the chamber, with the remaining unused colorant typically being disposed of with the container. As the disposal of colorant in excess is subject to specialized disposal requirements (and increased fees associated therewith), the actual costs associated with the inefficient use of colorant by existing systems often exceed those associated with only the wasted colorant. Another concern with current systems is the volume of waste generated as a result of the disposal of the rigid design and construction of existing colorant containers.

### SUMMARY

In one aspect, the present technology provides a storage system for a colorant that includes a container and a valve. The container defines a fluid-tight, sealed chamber including a colorant. Commonly, the valve is positioned at and sealed to an opening provided in the container and is configured to provide fluid communication between the ambient environment surrounding the storage system and the chamber.

According to any embodiment, the colorant may include less than about 1000 ppm of a fungicide. According to any embodiment, the colorant may include approximately 250 ppm (e.g., 100 ppm) of a fungicide. According to any embodiment, the colorant may be substantially free of fungicide. According to any embodiment, the colorant may include no fungicide. Fungicide as described herein may refer to any one or more substances and/or microorganisms that are configured to destroy, deter, kill, inhibit the growth of, and/or render harmless fungi and/or spores. A fungicide as described herein is not intended to include a substance(s) that may have fungicidal properties, but which is included in a colorant for a primary purpose(s) other than to destroy, deter, kill, inhibit the growth of and/or render harmless fungi and/or spores. A fungicide as used herein may not include a heavy metal such as copper, mercury, nickel, arsenic, cadmium, zinc, cobalt, lead, iron, manganese, or combinations of two or more thereof. A fungicide as used herein may refer to fungicides commonly used in colorants including 3-iodo-2-propynyl butyl carbamate (IPBC), chlorothalonil, zinc pyrithione, 2-N-octyl-4-isothiazalin-3-one, thiabendazole, diiodomethyl p-tolyl sulfone, dichloroctylisothiazolone, or combinations of two or more thereof.

According to any embodiment, the colorant may include less than about 100 ppm of a biocide (such as, e.g., a bactericide). According to any embodiment, the colorant may include less than about 75 ppm (e.g., 50 ppm) of a biocide. Bactericide as described herein may refer to any one or more substances and/or microorganisms (such as, e.g., a disinfectant, antiseptic, antibiotic, etc.) that are configured to destroy, deter, kill, and/or render harmless bacteria. A bactericide as used herein may not include a heavy metal such as copper, mercury, nickel, arsenic, cadmium, zinc, cobalt, lead, iron, manganese, or combinations of two or more thereof. A bactericide as described herein is not intended to include a substance(s) that may have bactericidal properties, but which is included in a colorant for a primary purpose(s) other than to destroy, deter, kill, and/or render harmless bacteria. A bactericide as used herein may refer to bactericides commonly used in colorants including 1,2-benzisothiazol-3(2H)-one (BIT), 2-methyl-4-isothiazolin-3-one, 5-chloro-2-methyl-4-isothiazolin-3-one (CIT), glutaraldehyde, sodium o-phenylphenate, ortho-phenylphenol, zinc 2-pyridinethiol-1-oxide, or combinations of two or more thereof.

According to any embodiment, the colorant, once sealed within the chamber, remains unexposed to the ambient environment until dispensed. According to any embodiment, the container includes a flexible material. According to any embodiment, the container includes a collapsible material.

In another aspect the present technology provides a tinting system that includes a storage system and a colorant dispenser. Commonly, the colorant dispenser includes an inlet configured to be releasably and removably attached to the valve of the container and optionally a discharge nozzle.

According to any embodiment, the colorant dispenser includes a housing, a dosing valve, a pump, or a combination thereof. According to any embodiment, the colorant is dispensed from the container through the valve, to the inlet, through the dosing valve, and out the discharge nozzle. According to any embodiment, the colorant dispenser is configured to dispense a volume of colorant accurate to about 1/48^{th} ounce. According to any embodiment, the housing includes at least one receiving structure configured to releasably support at least one of the containers.

In another aspect, the present technology provides a method for tinting a composition that includes releasably and removeably attaching a valve of a container of a colorant storage system according to any embodiment to an inlet of a colorant dispenser and dispensing colorant from a discharge nozzle of the colorant dispenser. According to any embodiment, a first amount of the colorant is dispensed in response to receiving instructions from a user.

### BRIEF DESCRIPTION OF THE DRAWINGS

FIG. 1 illustrates a tinting system, according to an example embodiment.

FIG. 2 illustrates a colorant storage system, according to an example embodiment.

FIG. 3A illustrates a colorant storage system including a support housing, according to an example embodiment.

FIG. 3B illustrates an exploded view of the colorant storage system and support housing of FIG. 3A, according to an example embodiment.

FIG. 4 illustrates a cross-sectional view of a receiving structure ofa colorant dispenser and a perspective view of a colorant storage system of a tinting system, according to an example embodiment.

FIG. 5 illustrates a cross-sectional view of a receiving structure of a colorant dispenser including a mixing structure, according to an example embodiment.

FIG. 6 is a flowchart of a method of operating a tinting system, according to an example embodiment.

FIG. 7 is a flowchart of a method of operating a tinting system, according to an example embodiment.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

As used herein, “substantially free” refers to less than about 2 wt % of the total colorant including less than about 1 wt %, less than about 0.5 wt %, less than about 0.1 wt %, or essentially free of detectable amounts.

It has been found that a tinting system having a colorant storage system and a colorant dispenser as described herein advantageously provides an easier to operate, more efficient, more environmentally friendly, and more economical alternative to conventional tinting systems. In particular, once sealed within a chamber of the colorant storage system, colorant stored by the colorant storage system remains unexposed, or substantially unexposed, to the ambient environment, even after the colorant dispenser has been fluidly coupled to the colorant dispenser. Furthermore, during use of a tinting system according to any embodiment described herein, only the quantity of colorant dispensed by the colorant dispenser is exposed to the ambient environment, with the undispensed colorant remaining within the colorant storage system remaining unexposed, or substantially unexposed, to the ambient environment. In addition to isolating the colorant from the ambient environment, the colorant storage system also prevents colorant within the colorant storage system from exposure to remnant colorant previously used with the tinting system. By maintaining colorant isolated from the ambient environment and from remnant colorant (and any contaminants that may be associated therewith), the colorant storage system significantly, or entirely, eliminates the amount of fungicide and/or bactericide needed to be included in the colorant to prevent microorganism growth, as compared to fungicide and/or bactericide levels that would be used with a similar colorant being dispensed by a conventional tinting system. In addition to reducing/obviating the need for fungicide and/or bactericide, the flexible, collapsible configuration of the colorant storage system significantly minimizes the volume of waste generated by the tinting system (up to 99%) as compared to the waste generated when using colorant supplied in conventional containers.

In contrast to conventional colorant containers and conventional colorant dispensers—in which the conventional container is opened and colorant is poured into the conventional dispenser to refill the conventional dispenser—the self-contained, sealed nature of the colorant storage system and the colorant dispenser of a tinting system according to any embodiment described herein is more efficient, easier to use, and more cost effective than conventional tinting systems. In particular, the colorant storage system, which only requires that a user attach a new colorant storage system into the colorant dispenser to refill the colorant dispenser, avoids the problems of spillage (as a result of, e.g., user inattentiveness; the configuration of the conventional dispenser and/or weight of the conventional container that may make pouring colorant into a conventional dispenser awkward and difficult; etc.) and waste (as a result of, e.g., a user having insufficient time/patience/ability to pour the entirety of the colorant from a conventional container into a conventional dispenser; a user accidently pouring colorant into the wrong receptacle of a conventional dispenser; a user prematurely refilling the conventional dispenser; etc.) frequently associated with the refilling of conventional tinting systems.

Additionally, because the colorant storage system defines a known volume, a colorant dispenser according to any embodiment may advantageously be configured to monitor the quantity of colorant remaining within the colorant storage systems fluidly coupled to the colorant dispenser during operation of the tinting system. In contrast, the unmetered and uncontrolled manner in which colorant is poured into a conventional dispenser renders it difficult, if not entirely impossible, to accurately monitor the amount of colorant remaining during use of the conventional tinting system. By allowing for real-time monitoring of the volume of colorant remaining within a colorant storage system attached to the colorant dispenser, the tinting system may advantageously reduce or prevent undesirable situations—such as, e.g., colorant is wasted as a result of a user prematurely refilling the colorant dispenser; operation of the tinting system being interrupted as a result of the dispenser having an insufficient amount of colorant; etc.—that conventional tinting systems may face as a result of not being able to provide such real-time colorant volume monitoring.

In one aspect, the present technology provides a storage system for a colorant that includes a container and a valve. The container defines a fluid-tight, sealed chamber including a colorant. Commonly, the valve is positioned at and sealed to an opening provided in the container and is configured to provide fluid communication between the ambient environment surrounding the storage system and the chamber.

According to any embodiment, the colorant includes less than about 1000 ppm of a fungicide. For example, the colorant may include less than about 750 ppm of a fungicide including 500 ppm, 250 ppm, and 100 ppm. Alternatively, the colorant may be essentially free of fungicide or include no fungicide. According to any embodiment, the colorant includes less than about 100 ppm of a biocide. This may include, without limitation, the colorant including less than about 90 ppm of a biocide, including less than about 80 ppm, less than about 70 ppm, or less than about 60 ppm of a biocide.

The significant difference between the levels of biocides (e.g. fungicide and/or bactericide) used for colorants used in existing tinting systems and the levels included in a colorant 111 stored by a colorant storage system 100 according to any embodiment, is representatively illustrated by Table 1 and Table 2 below. In particular, Table 1 is representative of example levels of various fungicides/biocides that are used in colorants when colorants are stored in conventional storage containers and used in conventional tinting systems. Table 2 is representative of the reduced levels of the various example fungicides/biocides listed in Table 1 that could be used in a colorant 111 that is stored in a colorant storage system 100 according to any embodiment herein. Biocide as described herein may refer to any one or more substances and/or microorganisms that are configured to destroy, deter, kill, inhibit the growth of, and/or render harmless undesirable organisms. A biocide may, e.g., refer to a bactericide and/or a fungicide. A biocide as described herein is not intended to include a substance(s) that may have biocidal properties, but which is included in a colorant for a primary purpose(s) other than to destroy, deter, kill, inhibit the growth of and/or render harmless undesirable organisms within the colorant.

As will be understood, the example fungicides/biocides and the example fungicide/biocide levels listed in Table 2 are intended for illustrative purposes only. In particular, the example fungicides/biocides listed in Table 2 are not an exhaustive list of the types of fungicides/biocides that may be used in a colorant 111 that is stored within the colorant storage system 100. Additionally, the example quantities of fungicides/biocides listed in Table 2 that may be present in a colorant 111 stored in a colorant storage system 100 are provided for illustrative purposes only. In particular, quanties of fungicides/biocides other than those listed in Table 2 may be used in a colorant 111 stored in a colorant storage system 100. For example, a colorant 111 stored in a colorant storage system 100 may include fungicide/biocide levels similar to those used when colorant is stored in conventional containers (e.g. levels such as representatively listed in Table 1).

TABLE 1
Colorant fungicide/biocide levels (colorant
stored in a conventional container)

| | |
|---|---|
| Iodopropynyl butylcarbamate (IPBC) | 1500-5100 |
| Octhilinone (OIT) | 1000-1400 |
| Benzisothiazolinone (BIT) | 200-600 |
| Methylisothiazolinone (MIT) | 200-400 |
| Zinc Pyrithione (ZPT) | 200-500 |
| Chloroisothiazolinone (CIT) | 35-50 |

TABLE 2
Colorant fungicide/biocide levels (colorant
stored in a colorant storage system 100)

| | |
|---|---|
| Iodopropynyl butylcarbamate (IPBC) | 0-1000 |
| Octhilinone (OIT) | 0-500 |
| Benzisothiazolinone (BIT) | ≤150 |
| Methylisothiazolinone (MIT) | ≤150 |
| Zinc Pyrithione (ZPT) | ≤150 |
| Chloroisothiazolinone (CIT) | ≤35 |

According to any embodiment, the colorant, once sealed within the chamber, may remain unexposed to the ambient environment until dispensed. According to any embodiment, the container includes a flexible material. For example, the container includes a collapsible material.

The colorant may include a liquid, gel, solid, or combination of two or more thereof. According to any embodiment, the colorant has a viscosity from about 30 KU (Krebs Units, i.e. a viscosity measurements made with a Stormer viscometer that represents a weight in grams that will turn a paddle-type rotor, submerged in the sample, 100 revolutions in 30 seconds) and about 200 KU. This may include the colorant having a viscosity from about 35 KU to about 190 KU, from about 40 KU to about 170 KU, or from about 50 KU to about 150 KU.

According to any embodiment, the chamber may define a volume from about 0.25 gallons and about 3 gallons. The container may optionally include a machine-readable label on an exterior surface of the container. As one example, the machine-readable label may encode information indicative of the colorant.

A first attachment structure may be provided on an exterior portion of the container that is configured to engage a corresponding optional second attachment structure provided on a colorant dispenser. According to any embodiment, the container is configured to be releasably attached to a colorant dispenser.

In one aspect, a tinting system includes a storage system according to any embodiment and a colorant dispenser. The colorant dispenser includes an inlet configured to be releasably and removably attached to the valve of the container and optionally a discharge nozzle.

According to any embodiment, the colorant dispenser includes a housing, a dosing valve, a pump, or a combination of two or more thereof. The colorant is dispensed from the container through the valve, to the inlet, through the dosing valve, and out the discharge nozzle.

According to any embodiment, the container includes a first attachment structure on an exterior portion of the container. The first attachment structure may be configured to engage a corresponding second attachment structure provided on the colorant dispenser. The container may be configured to be supported within and optionally attached to a rigid or semi-rigid support housing that optionally includes an attachment structure on an exterior portion thereof. According to any embodiment, the container is configured to be releasably attached to the support housing. The support housing may be configured to be reusable with a subsequent container upon removing the container from the support housing. According to any embodiment, the support housing is disposable, and optionally biodegradable.

The housing includes at least one receiving structure configured to releasably support at least one of the containers. The housing may also include at least two, and optionally more than two of the receiving structures configured to releasably support at least two of the containers. For example, the housing may include from one to sixty-four (e.g. from six to twenty) receiving structures configured to releasably support the containers.

The tinting system may optionally include an agitator configured to agitate the colorant while the valve of the container is attached to the inlet of the colorant dispenser. According to any embodiment, the agitator is configured to vibrate the container and/or rotate the container relative to at least a portion of the housing. According to any embodiment, the agitator may include a mixing structure configured to be positioned at least partially within the container chamber. According to any embodiment, the mixing structure may be supported by the container, and may, for example, be releasably secured to the valve. According to any embodiment, the mixing structure may be supported by the housing, and may be configured to be inserted through the valve and into the container chamber. The agitator may be activated by a user. Additionally, or alternatively, the agitator may be activated at time intervals by a controller of the colorant disperser.

The tinting system may include a sensor configured to detect a quantity of colorant dispensed out the discharge nozzle. According to any embodiment, the colorant dispenser is configured to dispense a volume of colorant accurate from about 1/16^{th} ounce to about 1/768^{th} ounce, more specifically from about 1/36^{th} ounce to about 1/512^{th} ounce, and more specifically from about 1/48^{th} ounce to about 1/384^{th} ounce.

The container may include a machine-readable label on the exterior surface of the container. The colorant dispenser may optionally include a scanner configured to read the machine-readable label. According to any embodiment, the machine-readable label encodes information indicative of the colorant. According to any embodiment, if the wrong container (determined, e.g., based on information read from the machine-readable label) is placed in a wrong area of the receiving structure, the colorant dispenser will not dispense the colorant.

The colorant dispenser may include a controller that is configured to operate the pump to dispense colorant out the discharge nozzle and from the container responsive to receipt of instructions from a user. According to any embodiment, the instructions may be received via a graphical user interface displayed by an optional display provided by the colorant dispenser.

According to any embodiment, the tinting system is a paint tint system, such as, e.g. an aqueous-based paint tinting system. A method for tinting a composition may include releasably and removeably attaching a valve of a container of a colorant storage system according to any embodiment to an inlet of a colorant dispenser and dispensing colorant from a discharge nozzle of the colorant dispenser, with a first amount of the colorant being dispensed in response to receiving instructions from a user.

A second valve sealed to an opening provided in a second container that defines a second fluid-tight, sealed chamber in which a second colorant is stored is may be attached to a second inlet of the colorant dispenser. The second valve may be configured to provide fluid communication between the ambient environment and the second chamber. The second colorant may be dispensed from the discharge nozzle of the colorant dispenser, for example, in response to receiving instructions from a user. A third valve may be sealed to an opening provided in a third container that defines a third fluid-tight, sealed chamber in which a third colorant is stored is attached to a third inlet of the colorant dispenser. The third valve is configured to provide fluid communication between the ambient environment and the third chamber. The third colorant may be dispensed from the discharge nozzle of the colorant dispenser, for example, in response to receiving instructions from a user. According to any embodiment, a first amount of the third colorant is dispensed in response to receiving instructions from a user. According to any embodiment, the instructions are received from a user via a graphical user interface displayed by the colorant dispenser.

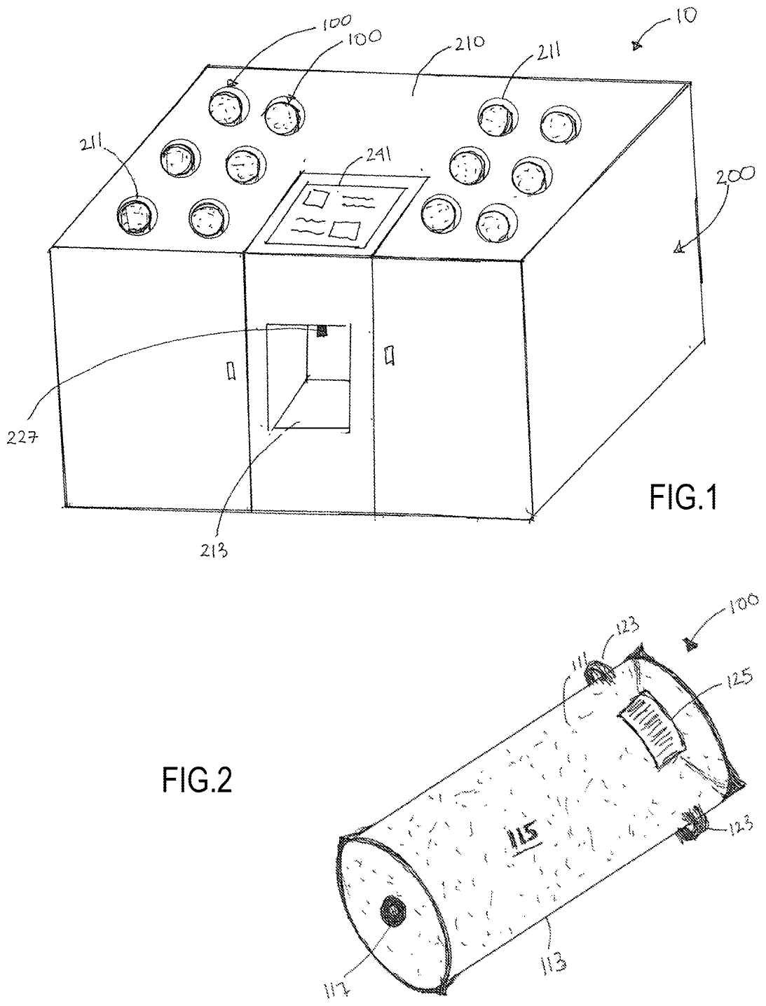

Referring generally to the FIGURES, a tinting system 10 and methods of its use are described according to various illustrative embodiments. As shown in FIG. 1, the tinting system 10 comprises a colorant storage system 100 and a colorant dispenser 200 configured to selectively dispense colorant 111 from the colorant storage system 100. The colorant storage system 100 of the tinting system 10 may be a colorant storage system 100 according to any embodiment described herein. Similarly, the colorant dispenser 200 of the tinting system 10 may be a colorant dispenser 200 according to any embodiment described herein. Additionally, although the colorant dispenser 200 and the colorant storage system 100 are each described as being components of a tinting system 10, a colorant dispenser 200 according to any embodiment may be used: independent of the tinting system 10, in any number of other systems, to dispense any number of other materials, and/or with any number of other storage systems. Similarly, a colorant storage system 100 according to any of the embodiment described herein may be used: independent of the tinting system 10, in any number of other systems, to store any number of other materials, and/or to with any number of other dispensing systems.

As illustrated by the colorant storage system 100 example of FIG. 2, a colorant storage system 100 according to any embodiment comprises a container 113 defining a substantially fluid-tight and sealed chamber 115 within which colorant 111 is stored. The chamber 115 may be defined by any volume. To facilitate handling of the colorant storage system 100, the volume of the chamber 115 may range from about 0.10 gallons to about 10 gallons, more specifically from about 0.15 gallons to about 5 gallons, and more particularly from about 0.25 gallons to about 3 gallons.

In any embodiment, a valve 117 is sealingly engaged about an opening in the container 113. The valve 117 may be defined by any number of various structures configured to reversibly or irreversibly establish fluid communication between the chamber 115 and the ambient environment. Following the initial filling and sealing of the colorant 111 within the chamber 115 of the container 113, the valve 117 may define the sole source of fluid communication between the colorant 111 within the chamber 115 and the ambient environment.

Any desired type of colorant 111 and/or other material may be stored within the chamber 115 of a colorant storage system 100 according to any embodiment. The colorant 111 stored within the chamber 115 may comprise any one or more of a solid, liquid, and gel. According to various aspects, the viscosity of the colorant 111 may range from about 200 centipoise to about 6000 centipoise, and more specifically from about 300 centipoise to about 3000 centipoise. According to various aspects, a KU (Krebs units) viscosity of the colorant 111 may be from about 50 KU to about 150 KU, more specifically from about 60 KU to about 110 KU, or even more specifically from about 70 KU to about 85 KU.

Given that the colorant 111 sealed within the chamber 115 remains unexposed (or substantially unexposed) to the ambient environment until it is dispensed by a colorant dispenser 200 according to any embodiment, a colorant storage system 100 according to any embodiment significantly minimizes the degree and/or risk of exposure of the colorant 111 to undesirable particles that could contaminate, spoil, or otherwise negatively affect the colorant 111. Accordingly, in contrast to colorant used to refill dispenser devices of existing tinting systems—the colorant 111 stored in the substantially or entirely air-tight chamber 115 of a colorant storage system 100 according to any embodiment does not require the same level of biocide (e.g. fungicides and/or bactericides) as would be required for colorant used in an existing tinting assembly. As such, the colorant 111 stored by a colorant storage system 100 according to any embodiment may contain any amount of fungicide as disclosed herein. In any aspect, the colorant 111 stored by a colorant storage system 100 according to any embodiment may contain no, or substantially no, fungicide. Additionally, the colorant 111 stored by a colorant storage system 100 according to any embodiment may contain less than about 50% of the amount of bactericide that would typically be used in a with an equal volume of colorant configured to be used in an existing tinting assembly. For example, the colorant 111 in a colorant storage system 100 according to any embodiment may contain any amount of bactericide as disclosed herein.

In any embodiment, the container 113 may be made of a flexible and collapsible material to facilitate the dispensing of colorant 111 from the sealed, substantially, or entirely, air-tight chamber 115. According to any embodiment, the collapsible nature of the container 113 may reduce the volume of waste generated by a colorant storage system 100 according to any embodiment to less than 10%, more specifically less than 5%, and even more specifically less than about 1% of the volume of waste generated by a use of a similar amount of colorant provided within the rigid containers of existing colorant storage systems 100. Alternatively, the container 113 of a colorant storage system 100 according to any embodiment may be made of any number of materials (including rigid or semi-rigid materials), with an optionally provided vent valve (not shown) formed on the container 113 allowing pressure within the chamber 115 to be equalized during dispensing of colorant 111 from the chamber 115. In any such colorant storage system 100 embodiments, the vent valve may optionally include one or more filters to prevent or minimize the ingress of any undesirable particles into the chamber 115.

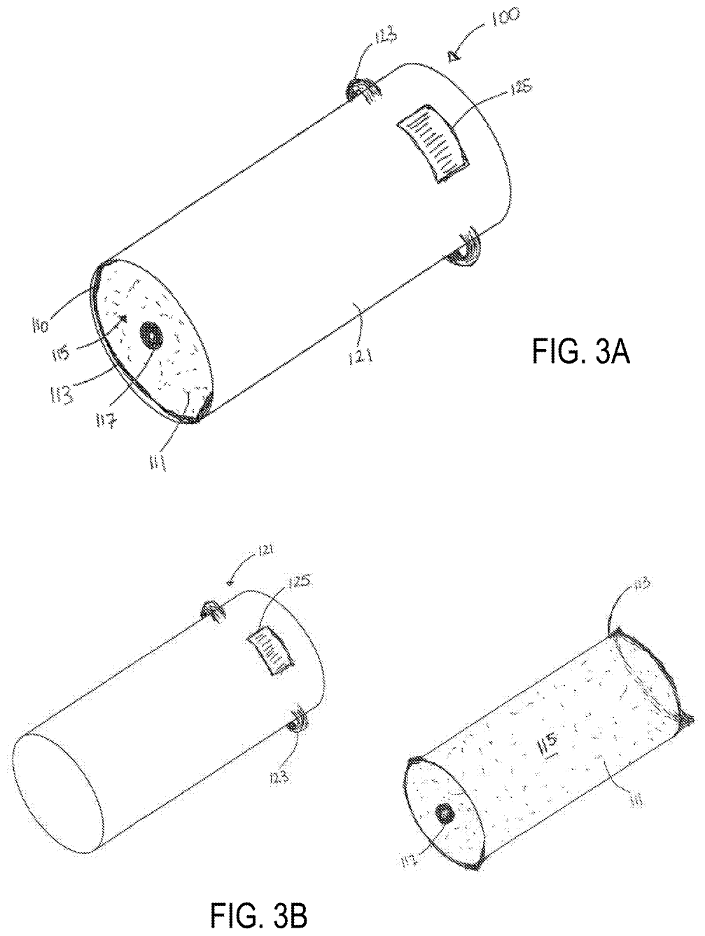

As illustrated by FIGS. 3A and 3B, a colorant storage system 100 according to any embodiment may optionally include a support housing 121 constructed of a rigid or semi-rigid material that partially or entirely surrounds the container 113. The optional support housing 121 may be fixedly engaged to the container 113, or may be releasably engaged to the container 113, allowing the support housing 121 to optionally be reused with a new container 113 filled with colorant 111 upon detaching and removing the initially engaged container 113 from the support housing 121.

The optional support housing 121 of a colorant storage system 100 according to any embodiment may be used to protect the container 113 during storage and transport of a colorant storage system 100. Additionally, or alternatively, the support housing 121 may be configured to assist in securing the colorant storage system 100 relative to a colorant dispenser 200 according to any embodiment. In any such aspect, the optional support housing 121 may be detached and removed from the container 113 following the engagement of the container 113 with the receiving structure 211 of the colorant dispenser 200, or may be shaped and sized to mate with and remain attach to a corresponding structure of a receiving structure 211 of a colorant dispenser 200 according to any embodiment until colorant 111 within the colorant storage system 100 has been depleted.

An optional attachment structure 123 may be provided on an exterior surface of the colorant storage system 100 according to any embodiment (i.e. on an exterior surface of the container 113 and/or on an exterior surface of an optional support housing 121, if included) to facilitate the releasable securement of a colorant storage system 100 according to any embodiment with the receiving structure 211 of a colorant dispenser 200 according to any embodiment. A machine readable label 125 encoding information (e.g., information representative of the colorant 111 within the chamber 115) may also optionally be provided on an exterior surface of the colorant storage system 100 according to any embodiment (i.e. on an exterior surface of the container 113 and/or on an exterior surface of an optional support housing 121, if included).

One illustrative embodiment of a colorant dispenser 200 that may be used with any embodiment of the colorant storage system 100 to define the tinting system 10 is shown in FIG. 1. The colorant dispenser 200 is defined by a housing 210 having at least one receiving structure 211 and at least one dispensing mechanism. According to any aspect, a colorant dispenser 200 according to any embodiment may optionally also include any one or more of an agitator, a controller, a display 241, a scanner 243, and one or more sensors.

The receiving structure 211 of the housing 210 engages and supports a colorant storage system 100 according to any embodiment so as to allow colorant 111 from the colorant storage system 100 to be dispensed by the dispensing mechanism. As illustrated by the example tinting system 10 embodiment of FIG. 1, a colorant dispenser 200 according to any embodiment may optionally include more than one (e.g., two, three, or any other number of) receiving structures 211, thereby allowing a plurality of colorant storage systems 100 (containing the same type of and/or differing types of colorant 111) according to any embodiment(s) to be concurrently supported by and engaged to the housing 210.

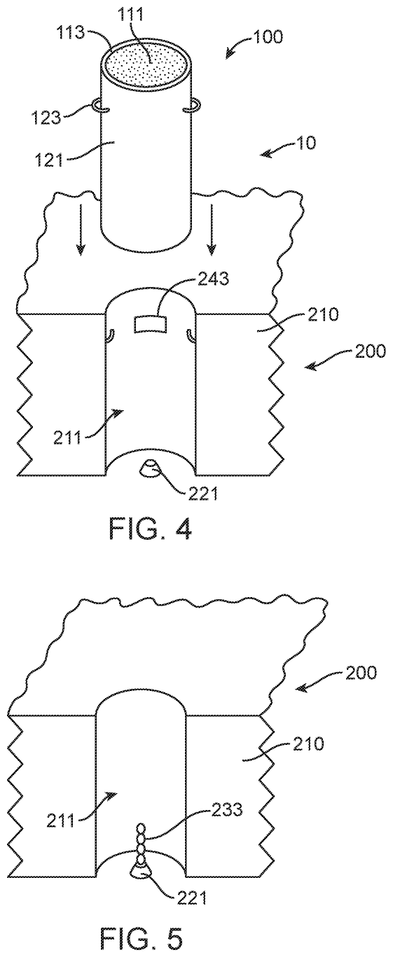

In any embodiment, the receiving structure 211 may be defined by any number of different structures or configurations that allow a colorant storage system 100 according to any embodiment to be securely and releasably engaged and supported by the housing 210. As shown by the illustrative tinting system 10 embodiment of FIG. 4, the receiving structure 211 of a colorant dispenser 200 according to any embodiment disclosed herein may comprise a receptacle defined by the housing 210 into which the entirety of, or a portion of, a colorant storage system 100 according to any embodiment may be inserted. As also illustrated by the tinting system 10 embodiment of FIG. 4, the shape, size, configuration and features of the receiving structure 211 may correspond to the physical characteristics of the colorant storage system 100 (or vice versa).

In any embodiment, colorant 111 from a colorant storage system 100 engaged to the receiving structure 211 of the housing 210 is dispensed by the dispensing mechanism of the colorant dispenser 200. The dispensing mechanism includes a fluid connector 221 defining an inlet of the dispensing mechanism, a dosing valve (not shown), a pump (not shown), and a discharge nozzle 227 defining an outlet of the dispensing mechanism. Following engagement of the colorant storage system 100 to the receiving structure 211, the fluid connector 221 of the dispensing mechanism is engaged to the valve 117 of the container 113 to fluidly and couple the colorant 111 with the dispensing mechanism. During operation of a tinting system 10 according to any embodiment, the dosing valve of the dispensing mechanism is selectively opened to permit metered amounts of colorant 111 to flow to the discharge nozzle 227, with operation of the pump assisting in transferring the colorant 111 to the discharge nozzle 227. Alternatively, in any tinting system 10 embodiment in which the fluid connector 221 of a dispensing mechanism according to any embodiment is located above the discharge nozzle 227, the pump may optionally be omitted from the dispensing mechanism, with the flow of colorant 111 from the container 113 and to the discharge nozzle 227 being driven entirely by gravity. According to any aspect, the dispensing mechanism may be configured to dispense a volume of colorant 111 accurate to about 1/48^{th} of an ounce, and more specifically, accurate to about 1/768^{th} of an ounce. According to any aspect, an orifice of the dosing valve of the dispensing mechanism may be from about 1 mm to about 5 mm.

The fluid connector 221 may be defined by any number of different structures or configurations that allow the fluid connector 221 to sealingly engage the valve 117 of a colorant storage system 100 according to any embodiment to fluidly couple the dispensing mechanism to the chamber 115 of the colorant storage system 100. According to any aspect, the fluid connector 221 of a colorant dispenser 200 may be attached to and extend from a location on the housing 210 that is within or adjacent the receiving structure 211, such that the fluid connector 221 may engage the colorant storage system 100 received within the receiving structure 211. In some embodiments, the fluid connector 221 may be located relative to the receiving structure 211 such that the fluid connector 221 and the valve 117 of a colorant storage system 100 according to any embodiment are automatically aligned and engaged upon attachment of the colorant storage system 100 to/within the receiving structure 211. For example, as shown in FIG. 4, according to one illustrative example of a tinting system 10, a colorant dispenser 200 according to any embodiment may comprise a fluid connector 221 defined by a spike that is positioned at the bottom of a receptacle defining the receiving structure 211. As a colorant storage system 100 according to any embodiment is lowered into the receptacle, the spike is aligned with and inserted through a valve 117 located along a lower surface of the colorant storage system 100, such that the container 113 and dispensing mechanism are fluidly coupled once the colorant storage system 100 has been fully inserted into and received by the receptacle.

As shown by the illustrative embodiment of FIG. 5, an optional agitator may be incorporated into a colorant dispenser 200 according to any embodiment to prevent settling of the colorant 111 following the attachment of a colorant storage system 100 according to any embodiment to the colorant dispenser 200. The agitator may be defined by any number of various mechanisms and arrangements configured to directly or indirectly agitate the colorant 111 within the chamber 115. For example, the agitator may be configured to indirectly agitate the colorant 111 by vibrating, shaking, rotating, or otherwise displacing a colorant storage system 100 according to any embodiment relative to the housing 210 of a colorant dispenser 200 according to any embodiment.

Alternatively, or additionally, the optional agitator of a colorant dispenser 200 according to any embodiment may agitate colorant 111 directly using a mixing structure 233 that at least partially extends within the chamber 115 of a colorant storage system 100 according to any embodiment. Referring to FIG. 5, according to one aspect, the mixing structure 233 may be defined by one or more fins or mixing blades attached to the fluid connector 221, with the mixing structure 233/fluid connector 221 structure being inserted into the chamber 115 upon engagement of the mixing structure 233/fluid connector 221 with the valve 117 of a colorant storage system 100 according to any embodiment. During use of the tinting system 10, a colorant dispenser 200 according to any embodiment may be configured to effectuate agitation of the colorant 111 of the colorant storage system 100 by rotating the mixing structure 233/fluid connector 221 relative to the housing 210.

According to any aspect, the optional agitator may instead be integrated into a colorant storage system 100 according to any embodiment, and may comprise a mixing structure defined by a rotatable mixing blade that is disposed within the chamber 115 of the container 113 and is rotatably attached to the valve 117, so as to allow the mixing blade to be selectively rotated by a colorant dispenser 200 according to any embodiment upon securement of the colorant storage system 100 to a receiving structure 211 of the colorant dispenser 200.

A tinting system 10 according to any embodiment a may be used to dispense colorant 111 for any number of different purposes. For example, a tinting system 10 according to any embodiment may be a paint tint system, with the colorant 111 dispensed by the tinting system 10 being used to tint a source of aqueous-based paint, oil-based paint, or any other type of paint. As shown by the example tinting system 10 of FIG. 1, the housing 210 of a colorant dispenser 200 according to any embodiment may optionally include a shelf 213 located below the discharge nozzle 227 on which a paint can (or other vessel into which the colorant 111 may be dispensed) may be supported during use of a tinting system 10.

Although the tinting system 10 may be operated according to any number of methods to dispense colorant 111, in any aspect, some or all of the operation of a tinting system 10 according to any embodiment may be controlled by an optional controller. For example, according to any aspect, a controller may be used to control and verify the operation of the dispensing mechanism to dispense a desired amount of colorant 111 from the discharge nozzle 227. As one example, the controller may monitor the volume of colorant 111 remaining within a colorant storage system 100 according to any embodiment. Upon receiving a request to dispense colorant 111, the controller may determine whether a sufficient quantity of colorant 111 remains within a first colorant storage system 100. If the controller determines that an insufficient amount of colorant 111 remains within the first colorant storage system 100, the controller may determine whether a second colorant storage system 100 containing the same type of colorant 111 that is attached to the colorant dispenser 200 contains a sufficient quantity. If so, the controller may instruct the colorant dispenser 200 to dispense the needed quantity of colorant from the two colorant storage systems 100. If the quantity of colorant 111 in the first and second colorant storage systems 100 (or in any additional colorant storages systems 100 containing the same type of colorant 111) is insufficient, the controller may generate an alert that insufficient colorant 111 remains to complete the requested dispensing of colorant 111.

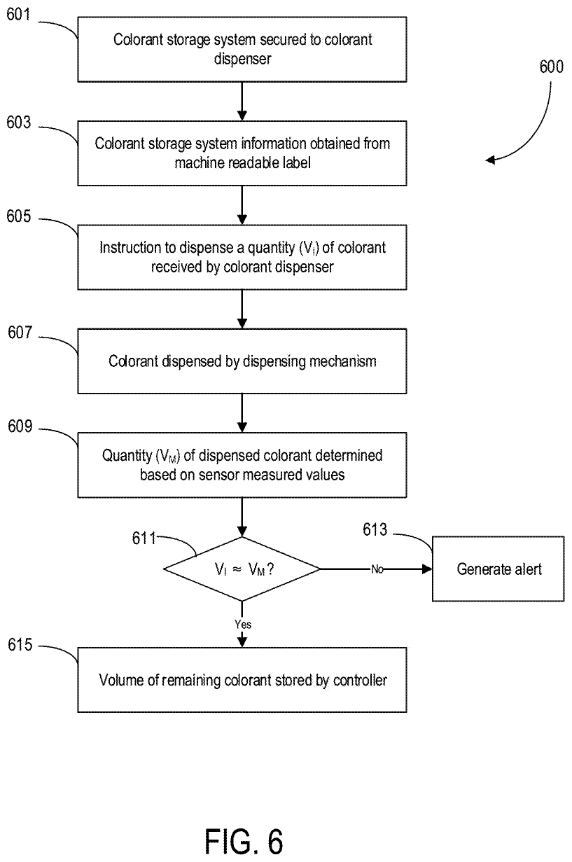

Another example method 600 of using an optional controller to assist in dispensing of colorant 111 by a tinting system 10 according to any aspect is illustrated by the flowchart of FIG. 6. As shown in FIG. 6, at step 601 a colorant storage system 100 according to any embodiment is secured relative to a receiving structure 211 of a colorant dispenser 200 according to any embodiment, such the that colorant 111 within the chamber 115 of the colorant storage system 100 is fluidly coupled to the dispensing mechanism of the colorant dispenser 200. According to any aspect, at optional step 603, an optional machine readable label 125 attached to the colorant storage system 100 may be read by an optional scanner 243 of the colorant dispenser 200 to determine information (e.g. colorant 111 type, volume, etc.) related to the colorant storage system 100 attached to the receiving structure 211. This information may be provided to and stored by the controller.

At step 605, instruction to dispense a quantity of colorant 111 is received by the controller (e.g., via a graphical user interface displayed in an optional display 241 of the colorant dispenser 200). At step 607, the controller operates the dosing valve and pump of the dispensing mechanism to dispense the quantity of colorant 111 input at step 605 through the discharge nozzle 227. According to any aspect, at optional step 609 the quantity of colorant 111 dispensed during step 607 may be verified by the controller using readings obtained from one or more optional sensors included by the colorant dispenser 200. Non-limiting examples of the types of sensors and/or the types of measurements that may be used to independently verify the quality of colorant 111 dispensed during step 607 include flow rate readings obtained from an optional flow sensor, weight measurements obtained by a scale, etc.

According to any aspect, at optional step 611, the quantity of colorant 111 calculated at step 609 may be compared by the controller to the quantity of colorant 111 input at step 605. In the event that a difference between the two quantities exceeds a predetermined threshold, at step 613, an optional alert may be generated by the controller and displayed by the optional display 241. If no difference is determined at step 611, or if the difference is below the predetermined threshold, colorant 111 volume information stored by the controller may be updated at step 615 to reflect the volume of colorant 111 remaining in the colorant storage system 100. According to any aspect, this updated volume stored by the controller at step 615 may be based on the difference between the initial volume of the colorant 111 in the colorant storage system 100 (which may be based on, e.g., information encoded by the optional machine readable label 125 and/or calculated using a sensed initial weight of the colorant storage system 100) and the quantity of colorant 111 dispensed during step 607 (which may be based on, e.g., the quantity received by the controller at step 605 and/or the quantity calculated at step 609).

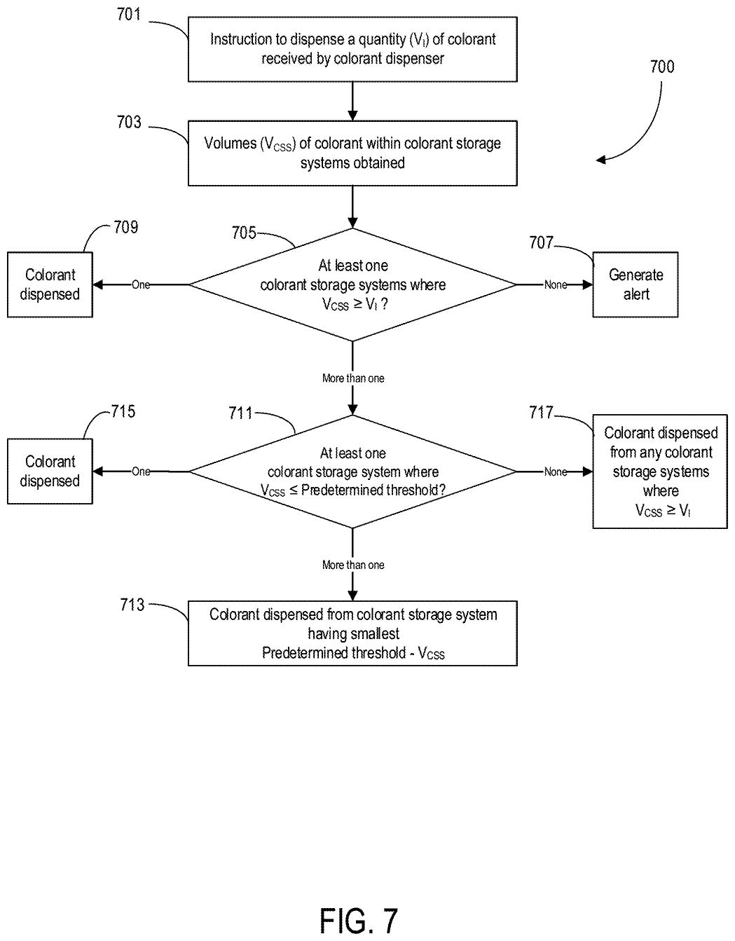

As noted above, a colorant dispenser 200 according to any embodiment may include multiple receiving structures 211, allowing a plurality of colorant storage systems 100 according to any embodiment(s) to be concurrently supported by and engaged to the housing 210. According to any aspect, any one or more of the plurality of colorant storage system 100_{A}, 100_{B}, . . . 100ₙ fluidly coupled to the colorant dispenser 200 may contain an identical, or substantially identical, colorant 111. Accordingly, as illustrated by the example method 700 of FIG. 7, the optional controller of a tinting system 10 according to any embodiment may optionally also be used to maximize the efficiency with which colorant 111 is dispensed by the tinting system 10.

According to any aspect, in response to receiving instructions at step 701 to dispense a quantity of a particular colorant 111, the optional controller at step 703 obtains the volumes of colorant 111 remaining within those colorant storage systems 100_{A}, 100_{B}, . . . 100ₙ of the tinting system 10 that contain the particular colorant 111 requested at step 701. At step 705, the controller may determine which, if any, of the colorant storage systems 100_{A}, 100_{B}, . . . 100ₙ contain a quantity of colorant 111 that is equal to or greater than the quantity input at step 701. Alternatively, according to any aspect, the controller at step 705 may determine which, if any, of the colorant storage systems 100_{A}, 100_{B}, . . . 100ₙ contain a quantity of colorant 111 that is equal to the volume of colorant 111 entered at step 701 plus a predetermined tolerance volume selected to account for potential variations in the colorant 111 volume measurements.

In the event that the controller at step 705 determines that no colorant storage system 100_{A}, 100_{B}, . . . 100ₙ contains sufficient colorant 111, at step 707, an optional alert may be generated by the controller and displayed by the optional display 241. Alternatively, if a single colorant storage system 100 is determined by the controller to contain sufficient colorant 111 at step 705, the controller at step 709 may instruct the dispensing mechanism to dispense the quantity of colorant 111 requested at step 701 from the colorant storage system 100 that has been determined at step 705 to contain the sufficient quantity of colorant 111.

In the event that the controller determines at step 705 that more than one colorant storage system 100_{A}, 100_{B}, . . . 100ₙ contains a sufficient quantity of colorant 111, the controller may use any number of variables, factors, and/or methods to select which of the remaining colorant storage systems 100_{A}, 100_{B}, . . . 100ₙ to dispense colorant 111 from. As illustrated by the example method 700 of FIG. 7, according to one aspect, at step 711 the controller may select a colorant storage system 100 based on a determination that a volume of colorant 111 within the colorant storage system 100 is less than or equal to a predetermined threshold volume. The predetermined threshold volume may correspond to any desired volume. According to any aspect, the predetermined threshold volume may correspond to a volume equal to or less than a maximum volume of colorant 111 that may be disposed of without being subject to any special disposal regulations and/or may correspond to an upper limit of an acceptable residual colorant 111 range set by a user.

According to any aspect, in the event that the controller at step 711 determines that more than one colorant storage system 100_{A}, 100_{B}, . . . 100ₙ contains a volume of colorant 111 less than the predetermined threshold, at step 713, the controller may dispense operating the dispensing mechanism to dispense the quantity of colorant 111 entered at step 701 from the colorant storage system 100 having the smallest difference between the predetermined threshold volume and colorant 111 volume as measured at step 711. In the event that no colorant storage system 100_{A}, 100_{B}, . . . 100ₙ is determined at step 711 to contain a volume of colorant 111 that is less than the predetermined threshold, the controller may utilize any number of methods of selecting which colorant storage system 100_{A}, 100_{B}, . . . 100ₙ to dispense the colorant 111 requested at step 701 from. For example, according to any aspect, the controller may at step 717 may instruct the dispensing mechanism to dispense colorant 111 from the colorant storage system 100 that has been attached to the colorant dispenser 200 for the longest period of time.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, or compositions, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

While certain a have been illustrated and described, it should be understood that changes and modifications can be made therein in accordance with ordinary skill in the art without departing from the technology in its broader aspects as defined in the following claims.

What is claimed is:

1. A storage system for a colorant comprising:
a container defining a fluid-tight, sealed chamber comprising a colorant; and
a valve positioned at and sealed to an opening provided in the container;
wherein:
the storage system is surrounded by an ambient environment; and
the valve is configured to provide fluid communication between the ambient environment and the colorant stored within the chamber.

2. The system of claim 1, wherein the colorant comprises less than about 1000 ppm of a fungicide.

3. The system of claim 2, wherein the colorant is free of fungicide.

4. The system of claim 1, wherein the colorant comprises less than about 100 ppm of a biocide.

5. The system of claim 4, wherein the colorant comprises less than about 75 ppm of a biocide.

6. The system of claim 1, wherein the colorant, once sealed within the chamber, remains unexposed to the ambient environment.

7. The system of claim 1, wherein the container comprises a flexible material.

8. The system of claim 1, wherein the colorant has a viscosity from about 50 KU to about 150 KU.

9. The system of claim 1, wherein the container comprises a machine-readable label on an exterior surface of the container.

10. The system of claim 1, wherein the container comprises a first attachment structure on an exterior portion of the container.

11. The system of claim 10, wherein the first attachment structure is configured to engage a corresponding second attachment structure provided on a colorant dispenser.

12. The system of claim 1, wherein the container is configured to be releasably attached to a colorant dispenser.

13. A tinting system, comprising:
the storage system of claim 1; and
a colorant dispenser;
wherein:
the colorant dispenser comprises an inlet configured to be releasably and removably attached to the valve of the container and optionally a discharge nozzle.

14. The tinting system of claim 13, wherein the colorant dispenser comprises a housing, a dosing valve, a pump, or a combination thereof.

15. The tinting system of claim 14, wherein the colorant is dispensed from the container through the valve, to the inlet, through the dosing valve, and out the discharge nozzle.

16. The tinting system of claim 13, wherein the container comprises a first attachment structure on an exterior portion of the container and the first attachment structure is configured to engage a corresponding second attachment structure provided on the colorant dispenser.

17. The tinting system of any one of claim 13, wherein the container is configured to be supported within and optionally attached to a support housing.

18. The tinting system of claim 17, wherein the housing comprises at least one receiving structure configured to releasably support at least one of the containers.

19. The tinting system of claim 13, wherein the container comprises a machine-readable label on the exterior surface of the container and the colorant dispenser comprises a scanner configured to read the machine-readable label.

20. A method for tinting a composition comprising:
providing the storage system of claim 1;
providing a colorant dispenser comprising a discharge nozzle and an inlet configured to be releasably and removably attached to the valve of the container;
attaching the valve of the container to the inlet of the colorant dispenser; and
dispensing the colorant from the discharge nozzle of the colorant dispenser.
